(19) United States
(12) Patent Application Publication
(10) Pub. No.: US 2022/0119737 A1
(43) Pub. Date: Apr. 21, 2022

(54) HIGH PERFORMING LAUNDRY DETERGENT

(71) Applicant: BASF SE, Ludwigshafen am Rhein (DE)

(72) Inventors: Hannah Ferree, Wyandotte, MI (US); Ashish Taneja, Wyandotte, MI (US); Keith E. Gutowski, Wyandotte, MI (US); Simone R. Bright, Wyandotte, MI (US)

(21) Appl. No.: 17/277,896

(22) PCT Filed: Sep. 19, 2019
(86) PCT No.: PCT/EP2019/075137

§ 371 Date: Mar. 19, 2021

Related U.S. Application Data
(60) Provisional application No. 62/736,035, filed on Sep. 25, 2018.

(30) Foreign Application Priority Data
Jan. 16, 2019 (EP) 19152050.1

(51) Int. Cl. C11D 1/831; C11D 11/00; C11D 3/30; C11D 3/37; C11D 17/04

(52) U.S. Cl. CPC C11D 1/831; C11D 11/0017; C11D 3/30; C11D 1/72; C11D 17/044; C11D 17/043; C11D 17/045; C11D 3/3788

(57) ABSTRACT

Described herein is a laundry detergent composition including at least one quaternized ethoxysulfated hexamethylene diamine, at least one ethoxylated polyethyleneimine and at least one surfactant. Also described herein is a method for removal of particulate, greasy, or bleachable stains from a fabric. Described herein is a unit dose article including the laundry detergent composition.

### FIELD OF THE INVENTION

The presently claimed invention relates to a laundry detergent composition comprising at least one quaternized ethoxysulfated hexamethylene diamine, at least one ethoxylated polyethyleneimine and at least one surfactant. The presently claimed invention further relates to a method for removal of particulate, greasy and bleachable stains from the fabric. The presently claimed invention also relates to a unit dose article comprising the laundry detergent composition.

### BACKGROUND OF THE INVENTION

Fabric, especially clothing, can become soiled with a variety of stains. Four common stains on the fabric are: greasy stains such as those due to oil, grease, sebum or make-up; particulate stains such as those due to clay, mud or soil; bleachable stains which are due to coffee, tea, tomato sauce, red wine or soy sauce and enzymatic stains which are caused due to organic substances such as egg, grass or chocolate. The level of cleaning which is necessary to remove said stains depends to a large degree upon the type of stain present, the amount of stain present and the degree to which the stain has contacted the fabric fibres. Bleachable stains require treatment with peroxides for their removal. Due to the high degree of charge associated with the clay, the clay stains on the fabric are a challenge to remove. A surfactant alone is not sufficient to remove unwanted stains due to clay. It requires additive ingredients such as clay dispersants. However, a high surface charge density of clay may repel these clay dispersants, thereby resisting any appreciable removing or carrying away of the clay into the laundry wash.

U.S. Pat. No. 6,525,012 B2 provides a liquid laundry detergent composition which provides hydrophilic soil cleaning benefits. The composition comprises a zwitterionic polymer, a polyamine dispersant and a surfactant system. The liquid laundry detergent removes hydrophilic soil stains from the hydrophilic fabrics, such as cotton fabric.

U.S. Pat. No. 6,579,839 B2 relates to liquid laundry detergent compositions which provide enhanced soil cleaning benefits. It discloses a liquid laundry detergent composition comprising from about 0.01 to about 20% by weight, of a zwitterionic polymer which comprises a polyamine backbone, from about 0.1 to about 7% by weight, of a polyamine dispersant, from about 0.01 to about 80% by weight, of a surfactant system and the balance carrier and adjunct ingredients.

Improvement of stain removal is a constant goal of the detergent Industry. A single laundry detergent is inefficient in removing all kinds of stains from the fabric. There is a need for a laundry detergent composition which has a wider application such that a single laundry detergent composition is efficient in removing stains as diverse as particulate, greasy and bleachable.

Therefore, it is an object of the presently claimed invention to provide a laundry detergent composition which alone can be used for washing fabric stained with a variety of different stains, thereby obviating the need for the use of additional stain removal ingredients.

### SUMMARY OF THE INVENTION

Surprisingly, it was found that a combination of a certain quaternized ethoxysulfated hexamethylene diamine and an ethoxylated polyethyleneimine provides enhanced benefits for removal of stains of a wide variety which otherwise cannot be removed by either of the individual components of the combination. The laundry detergent composition of the present invention is suitable for washing both white and colored fabrics.

The compositions comprising the quaternized ethoxysulfated hexamethylene diamine and ethoxylated polyethyleneimine with specific surfactant classes demonstrates removal of a wide variety of stains when the components are combined in certain ratios.

Thus, in an aspect, the presently claimed invention relates to a laundry detergent composition comprising

(a) at least one quaternized ethoxysulfated hexamethylene diamine;
(b) at least one ethoxylated polyethyleneimine; and
(c) at least one surfactant.

Component (a), i.e. the quaternized ethoxysulfated hexamethylene diamine, by itself is effective in removal of some particulate stains, component (b), i.e. the ethoxylated polyethyleneimine, is limited to the removal of oily stain, component (c), i.e. the surfactant, can remove greasy stain only. However, when the quaternized ethoxysulfated hexamethylene diamine and the ethoxylated polyethyleneimine are combined with the surfactants in the laundry detergent composition within certain ratios, the resulting laundry detergent composition is effective in removing a wide variety of different stains, such as particulate stains, greasy stains and bleachable stains that can other otherwise not be removed by the individual components.

‘Laundry’ herein refers to any item or article made from textile material or including textile materials itself, such as woven fabrics, non-woven fabrics and knitted fabrics. The textile materials can include natural or synthetic fibers such as silk fibers, linen fibers, cotton fibers, polyester fibers, polyamide fibers such as nylon, acrylic fibers, acetate fibers, and blends thereof, including cotton and polyester blends. The fibers can be treated or untreated. Exemplary treated fibers include those treated for flame retardancy. The term “linen” is used to describe certain types of laundry items including bed sheets, pillow cases, towels, table linen, table cloth, bar mops and uniforms.

In another aspect, the presently claimed invention relates to a method for removal of particulate, greasy and bleachable stains from the fabric, said method comprising the step of contacting the fabric with a solution comprising the laundry detergent composition as described herein above.

Particulate stains are stains due to soil, clay, mud or soot. They are predominately solid in nature and come in contact with fabrics in the course of their regular use. In the present invention, particulate stains include the stains due to different kinds of clays such as ground-in clay, Georgia red clay and black charm clay. Ground-in clay is the stain due to clay which gets adsorbed on the fabric and is tough to remove. It has about 70% silica, 15-20% aluminium oxide and some amount of magnesium oxide, ferric oxide and calcium oxide. ‘Georgia red clay’ is composed of unhydrated iron oxides. Black charm clay is predominantly composed of hydrous aluminium silicate.

Bleachable stains are stains caused due to tea, coffee, fruit juice or wine.

Greasy stains are stains due to oil, grease or make-up. Greasy stain also herein includes the stains due to dust sebum. Dust sebum is a complex mixture of palmitic acid, stearic acid, oleic acid, linoleic acid, coconut oil, olive oil, paraffin wax, cholesterol and squalene.

In another aspect, the presently claimed invention relates to the use of the liquid laundry detergent composition for the removal of particulate, greasy and bleachable stains from the fabric as described herein above.

In still another aspect, the presently claimed invention relates to a unit dose article comprising the laundry detergent composition as described herein above.

In another aspect, the presently claimed invention relates to a method for removal of particulate, greasy and bleachable stains from the fabric comprising the steps of diluting a water-soluble unit dose article in water by a factor of 50 to 1000 to form a wash liquor and then washing the fabrics with said wash liquor.

The ‘fabric’ can be any textile/fabric such as cotton (woven, knitted and denim), polyester (woven, knitted and micro fibre), nylon, silk, polycotton (polyester/cotton blends), polyester elastane, cotton elastane, viscose rayon, acrylic or wool. Particularly suitable textile/fabric substrates are cotton and polycotton.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the presently claimed invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Further-more, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to the applicable law.

In one aspect, the presently claimed invention relates to a laundry detergent composition comprising

(a) at least one quaternized ethoxysulfated hexamethylene diamine;
(b) at least one ethoxylated polyethyleneimine; and
(c) at least one surfactant.

In an embodiment, the laundry detergent composition does not comprise fatty acid, neutralized fatty acid soap and mixtures thereof.

Quaternized Ethoxysulfated Hexamethylene Diamine

The at least one quaternized ethoxysulfated hexamethylene diamine of the present invention is a compound of general formula (I)

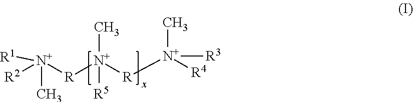

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M
M is H or alkali metal cation,
n is in the range of 15 to 30, and
x is in the range of 0 to 4.

The at least one quaternized ethoxysulfated hexamethylene diamine is a compound having an ability to remove clay particulate stains from the fabrics during washing. These compounds have the ability to adsorb onto the negatively charged layers of the clay particle and the ability to push apart the negatively charged layers of the clay so that the clay particle loses its cohesive force and can be removed in the wash water. These compounds, however, do not remove the oily stains such as dust sebum.

In a preferred embodiment, the at least one quaternized ethoxysulfated hexamethylene diamine is present in an amount from 0.5 wt. % to 30.0 wt. %, based on the total weight of the composition.

In a preferred embodiment, the at least one quaternized ethoxysulfated hexamethylene diamine has a weight average molecular weight (Mw) from 2000 to 8000 g/mol, more preferably from 2000 to 6000 g/mol, still more preferably from 2500 to 5500 g/mol and most preferably from 3000 to 5000 g/mol.

Weight average molecular weight “Mw” is determined according to DIN 55672-1 and referred to a polystyrene calibration standard.

Ethoxylated Polyethyleneimine

The at least one ethoxylated polyethyleneimine of the present invention contains repeating units of the general formula (II)

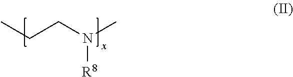

wherein
each R⁸ is independently selected from —(CH₂—CH₂—O)ₘH, or

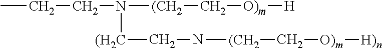

m is in the range of 12 to 30,
n is from 1 to 20, and
x is in the range of 10 to 30.

In a preferred embodiment, the at least one ethoxylated polyethyleneimine is present in an amount from 0.5 wt. % to 10.0 wt. %, based on the total weight of the composition.

In a preferred embodiment, the at least one ethoxylated polyethyleneimine has a weight average molecular weight (Mw) from 400 to 20,000 g/mol.

E is an ethyleneoxy unit having the formula —(CH₂—CH₂—O)ₘH, wherein the index m is from 12 to 30, preferably the number of ethoxylation averages about 20 per hydrogen atom which are bonded to a nitrogen atom in the backbone.

In a preferred embodiment n is from 1 to 17.

In a preferred embodiment x is from 10 to 30, more preferably x is from 10 to 25 and most preferably x is from 10 to 20.

The at least one ethoxylated polyethyleneimine is prepared according to the conventional methods known in the art. For example, aziridine is cationically polymerized to form polyethyleneimines in the presence of an acidic catalyst, and then the ethoxylation of polyethyleneimine is carried out by using ethylene oxide, as described in Houben-Weyl, Methoden der organischen Chemie, 4. Ed., Vol. 14/2, p. 440 ff. (1963) and Vol. E 20, p. 1367 f. (1987).

Surfactant

The laundry detergent composition of the present composition comprises at least one surfactant.

The at least one surfactant preferably comprises at least one anionic surfactant and at least one non-ionic surfactant.

The at least one anionic surfactant is preferably a compound of general formula (III)

R⁶—O—(C₂H₄O)ₙ—SO₃M (III)

wherein
R⁶ is linear or branched, unsubstituted C₆-C₂₂ alkyl,
n is from 1 to 20, and
M is selected from alkali metal or ammonium cation.

The compounds of general formula (III) are herein referred to as metal alkyl ether sulfates. The metal alkyl ether sulfates are produced by the ethoxylation of a fatty alcohol followed by treatment with an alkali.

For the purposes of the presently claimed invention, the term “C₆-C₂₂-alkyl” covers acyclic saturated hydrocarbon residues, which may be linear or branched and unsubstituted having 6 to 22 carbon atoms.

As used herein, “branched” denotes a chain of atoms with one or more side chains attached to it. Branching occurs by the replacement of a substituent, e.g., a hydrogen atom, with a covalently bonded aliphatic moiety.

Representative examples of linear and branched C₆-C₂₂ alkyl include, but are not limited to, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, 2-ethylhexyl, 2-propyl heptyl, 2-butyl-1-octyl, 2-pentyl-1-nonyl, isohexyl, isoheptyl, isooctyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, and isodocosyl.

Preferably R⁶ is selected from n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl and n-docosyl.

More preferably, R⁶ is selected from n-hexyl, n-heptyl, n-octyl, n-nonyl, n-decyl, n-undecyl, n-dodecyl, n-tridecyl, n-tetradecyl, n-pentadecyl and n-hexadecyl.

Most preferably R⁶ is selected from n-decyl, n-undecyl, n-dodecyl, n-tridecyl, n-tetradecyl, n-pentadecyl and n-hexadecyl.

In a preferred embodiment, n is from 1 to 15, more preferably from 1 to 10, and most preferably from 1 to 5.

In a preferred embodiment, the cation M is selected from sodium, potassium and ammonium cation.

Suitable metal alkyl ether sulfates are known and available commercially.

In an embodiment, the non-ionic surfactant is a poly(C₂-C₃)alkylene glycol mono-(C₈-C₂₂)-alkyl ether.

In a preferred embodiment, the poly(C₂-C₃)alkylene glycol mono-(C₈-C₂₂)alkyl ether is a compound represented by the general formula (IV)

R⁷—(O—CH₂—CH₂)_{q}(O—CH(CH₃)—CH₂)ᵣ—OH (IV)

wherein
R⁷ is linear or branched C₈-C₂₂-alkyl,
q is from 1 to 10, and
r is from 0 to 20.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₈-C₂₂ alkyl 8 to 22 carbon atoms.

Representative examples of linear and branched C₈-C₂₂ alkyl include, but are not limited to, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, 2-ethylhexyl, 2-propyl heptyl, 2-butyl-1-octyl, 2-pentyl-1-nonyl, isooctyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, and isodocosyl.

The poly(C₂-C₄)alkylene glycol mono-(C₈-C₂₂)-alkyl ether have a molecular weight from 300 to 2000 g/mol as determined by ¹H-NMR spectroscopy using for instance a 400 MHz spectrometer by Bruker. The molecular weight can be determined by the integration of the signals of the poly(C₂-C₄)alkylene glycol backbone and the comparison of this integral with the integral of the mono-(C₈-C₂₂)-alkyl signals.

The poly(C₂-C₄)alkylene glycol mono-(C₈-C₂₂)-alkyl ether can be prepared by the alkoxylation of a fatty alcohol. When the fatty alcohol which is used for the synthesis of poly(C₂-C₄)alkylene glycol mono-(C₈-C₂₂)-alkyl ether is derived from a natural source, it is common to have mixtures, e.g. of C₁₀ and C₁₆ alcohols, C₁₆ and C₁₈ alcohols or C₁₂ and C₁₄ alcohols. The fatty alcohol can also be synthesized (for example by oxo process) from olefin mixtures and, in this case, it is common to have mixtures, e.g. of C₁₃ and C₁₅ alcohols.

Suitable poly(C₂-C₄)alkylene glycol mono-(C₈-C₂₂)-alkyl ether is known and available commercially.

In a preferred embodiment, the at least one surfactant is present in an amount from 5.0 wt. % to 50.0 wt. %, based on the total weight of the composition.

In a preferred embodiment, the presently claimed invention relates to the laundry detergent composition comprising
(a) at least one quaternized ethoxysulfated hexamethylene diamine of general formula (I);

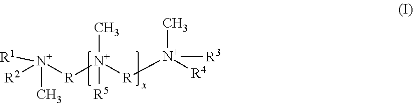

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M
M is H or alkali metal cation,
n is from 15 to 30, and
x is from 0 to 4;
(b) at least one ethoxylated polyethyleneimine; and
(c) at least one surfactant.

In another preferred embodiment, the presently claimed invention relates to the laundry detergent composition comprising
(a) at least one quaternized ethoxysulfated hexamethylene diamine of general formula (I);

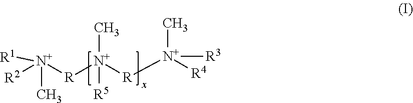

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M
M is H or alkali metal cation,
n is from 15 to 30, and
x is from 0 to 4;
(b) at least one ethoxylated polyethyleneimine containing repeating units of the general formula (II)

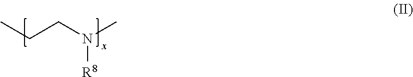

wherein
each R⁸ is independently selected from —(CH₂—CH₂—O)ₘH, or

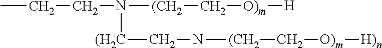

m is from 12 to 30,
n is from 1 to 20, and
x is from 10 to 30.
(c) at least one surfactant.

In another preferred embodiment, the presently claimed invention relates to the laundry detergent composition comprising
(a) at least one quaternized ethoxysulfated hexamethylene diamine of general formula (I);

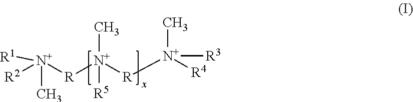

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M
M is H or alkali metal cation,
n is from 15 to 30, and
x is from 0 to 4;
(b) at least one ethoxylated polyethyleneimine containing repeating units of the general formula (II)

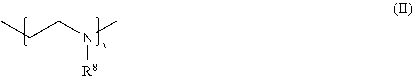

wherein
each R⁸ is independently selected from —(CH₂—CH₂—O)ₘH, or

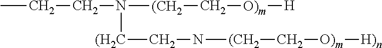

m is from 12 to 30,
n is from 1 to 20, and
x is from 10 to 30.
(c) at least one surfactant comprising at least one anionic surfactant and at least one non-ionic surfactant.

In another preferred embodiment, the presently claimed invention relates to the laundry detergent composition comprising
(a) at least one quaternized ethoxysulfated hexamethylene diamine of general formula (I);

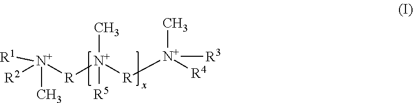

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4;
(b) at least one ethoxylated polyethyleneimine containing repeating units of the general formula (II)

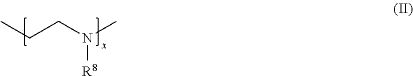

wherein
each R⁸ is independently selected from —(CH₂—CH₂—O)ₘH, or

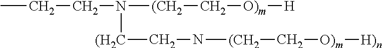

m is from 12 to 30,
n is from 1 to 20, and
x is from 10 to 30.
(c) at least one surfactant comprising at least one anionic surfactant of general formula (III)

R⁶—O—(C₂H₄O)ₙ—SO₃M (III)

wherein
R⁶ is selected from linear or branched, unsubstituted C₆-C₂₂ alkyl,
n is from 1 to 20, and
M is selected from alkali metal or ammonium cation;
and at least one non-ionic surfactant of general formula (IV)

R⁷—(O—CH₂—CH₂)_{q}(O—CH(CH₃)—CH₂)ᵣ—OH (IV)

wherein
R⁷ is linear or branched C₈-C₂₂-alkyl,
q is from 1 to 10, and
r is from 0 to 20.

In yet another preferred embodiment, the presently claimed invention relates to the laundry detergent composition comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine; and
(c) 5.0 wt. % to 50.0 wt. % of at least one surfactant.

In another aspect, the presently claimed invention is directed to a laundry detergent composition which is in the form of a liquid. “Liquid” as used herein means that a continuous phase or predominant part of the laundry detergent composition is liquid, and that the composition is which flows freely and is of constant volume at ambient temperature (i.e., suspended solids may be included). ‘Deformable’ herein denotes that the composition will flow on applying pressure or on gentle shaking. Gels are included in the definition of ‘liquid’ as used herein.

In a preferred embodiment, the liquid laundry detergent composition comprises
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant;
(d) 10.0 wt. % to 80.0 wt. % of at least one additive; and
(e) 2.0 wt. % to 84.0 wt. % of water;
   in each case based on the total weight of the composition.

In another aspect, the presently claimed invention is directed to a laundry detergent composition which is in the form of a solid. The term ‘solid’ refers to a composition which is generally in a shape-stable form at ambient temperature, for example a powder, particle, agglomerate, flake or granule. A solid may have varying degrees of shape stability and will substantially retain its shape under moderate stress, pressure or mere gravity. Preferably, the solid detergent composition is in the form of powder.

In a preferred embodiment, the solid laundry detergent composition comprises
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant; and
(d) 10.0 wt. % to 80.0 wt. % of at least one additive;
   in each case based on the total weight of the composition.

Additives

The laundry detergent composition which is in the form of a liquid or a solid comprises at least one additive.

In case of the liquid laundry detergent composition, the at least one additive is selected from the group of polyacrylates, dye transfer inhibitors, solvents, enzymes, bleaching compounds, chelating agents, builders, alkali metal hydroxide, viscosity modifiers and fragrances.

In case of the solid laundry detergent composition, the at least one additive is selected from the group of polyacrylates, dye transfer inhibitors, enzymes, bleaching compounds, chelating agents, builders, alkali metal hydroxide, fillers and fragrances.

Polyacrylates

Polyacrylates that are suitable for the use as cleaning agents include, but are not limited to, polyacrylic acid, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile and hydrolyzed acrylonitrile-methacrylonitrile copolymers.

Dye Transfer Inhibitors

Suitable dye transfer inhibitors are, in accordance with the invention, for example, homopolymers, copolymers and graft polymers of 1-vinylpyrrolidone, 1-vinylimidazole and 4-vinylpyridine N-oxide. Reaction products of homopolymers and copolymers of 4-vinylpyridine with chloroacetic acid are also suitable as dye transfer inhibitors.

Solvents

The liquid laundry detergent composition according to the presently claimed invention contains water in an amount (based on the total composition) from 2.0 wt. % to 84.0 wt. %, whereby this, if desired, can also be replaced proportionally by a water-soluble solvent component. Non-aqueous solvents that may be used in the liquid laundry detergent compositions can be selected from monovalent or polyvalent alcohols, alkanolamines or glycol ethers. The solvents are preferably selected from ethanol, n-propanol, isopropanol, ethylene glycol, butanediol, glycerol, diethylene glycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether or propylene glycol propyl ether, dipropylene glycol monomethyl ether, dipropylene glycolethyl ether, diisopropylene glycol monomethyl ether, diisopropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether and mixtures thereof.

Enzymes

Enzymes can be added to the laundry detergent composition for a wide variety of fabric laundering purposes, including removal of protein-based, carbohydrate-based, or triglyceride-based stains and for the prevention of refugee dye transfer as well as for fabric restoration. Preferred enzymes are selected from cellulases, proteases, amylases, lipases and mixtures thereof.

The choice of the enzymes is governed by several factors such as the pH-activity and/or stability optima, the thermostability, the stability versus active detergents and the builders.

Along with enzymes, enzyme stabilizing systems may also be used, such as for example, calcium ions, boric acid, boronic acids, propylene glycol and short chain carboxylic acids.

Bleaching Compounds

The bleaching compounds may be bleach catalysts or bleach activators and combinations thereof.

The laundry detergent compositions according to the invention can comprise one or more bleach catalysts. Bleach catalysts can be selected from the group of oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-amine complexes.

The laundry detergent compositions according to the presently claimed invention can comprise one or more bleach activators, for example, tetraacetyl ethylene diamine, tetraacetylmethylene diamine, tetraacetylglycoluril, tetraacetylhexylenediamine, acylated phenolsulfonates such as for example n-nonanoyloxybenzene sulfonates or isononanoyloxybenzene sulfonates, N-methylmorpholinium acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHΓ’) or nitrile quats (trimethylammonium acetonitrile salts).

Chelating Agents

The composition according to the invention may include a chelating/sequestering agent such as an aminocarboxylic acid, a condensed phosphate, a phosphonate and a polyacrylate. In general, a chelating agent is a molecule capable of coordinating (i.e., binding) the metal ions commonly found in natural water to prevent the metal ions from interfering with the action of the other detersive ingredients of a cleaning composition. Useful aminocarboxylic acids include, for example, n-hydroxyethyliminodiacetic acid, nitrilotriacetic acid (NTA), ethylenediaminetetraacetic acid (EDTA), N-hydroxyethyl ethylenediaminetriacetic acid (HEDTA), diethylenetriamine pentaacetic acid (DTPA), methylglycinediacetic acid (MGDA) and glutamic acid diacetic acid (GLDA). Examples of condensed phosphates are sodium and potassium orthophosphate, sodium and potassium pyrophosphate, sodium tripolyphosphate and sodium hexametaphosphate.

Builders

The laundry detergent composition according to the presently claimed invention may also include a detergent builder to assist in controlling mineral hardness. Inorganic or phosphorus-containing detergent builders include, but are not limited to, the alkali metal, ammonium and alkanol ammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates.

Examples of silicate builders are the alkali metal silicates, particularly those having a SiO₂:Na₂O ratio from 1.6:1 to 3.2:1 and the layered silicates.

Examples of carbonate builders are the alkaline earth and alkali metal carbonates. Aluminosilicate builders are of great importance in most currently marketed detergent compositions and can also be a significant builder ingredient in liquid detergent formulations.

Useful aluminosilicate ion exchange materials are commercially available. These aluminosilicates can be crystalline or amorphous in structure and can be naturally occurring aluminosilicates or synthetically derived. Synthetic crystalline aluminosilicate ion exchange materials are available under the designations Zeolite A, Zeolite P (B), Zeolite MAP and Zeolite X.

Organic detergent builders include a wide variety of polycarboxylate compounds. As used herein, “polycarboxylate” refers to compounds having a plurality of carboxylate groups, preferably at least 3 carboxylates. Polycarboxylate builder can generally be added to the composition in acid form but can also be added in the form of a neutralized salt. When utilized in the salt form, alkali metals, such as sodium, potassium, lithium and alkanolammonium salts are preferred.

One important category of polycarboxylate builders encompasses the ether polycarboxylates, including oxydisuccinate. Suitable ether polycarboxylates also include cyclic compounds, particularly alicyclic compounds.

Other useful detergency builders include the ether hydroxypolycarboxylates, copolymers of maleic anhydride with ethylene or vinyl methyl ether, 1,3,5-trihydroxybenzene-2,4,6-trisulphonic acid and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5 tricarboxylic acid, carboxymethyloxysuccinic acid, and soluble salts thereof. Citrate builders, e.g., citric acid and soluble salts thereof (particularly sodium salt), are polycarboxylate builders of importance for liquid detergent formulations due to their availability from renewable resources and their biodegradability. Citrates can also be used in granular compositions, especially in combination with zeolite and/or layered silicate builders.

Alkali Metal Hydroxide

The laundry detergent compositions of the presently claimed invention may also include alkali metal hydroxide as an additive. Preferable alkali metal hydroxide is selected from sodium hydroxide, potassium hydroxide and mixtures thereof.

Viscosity Modifiers

The liquid laundry detergent compositions of the present invention may also comprise viscosity modifiers or thickeners for obtaining a desired viscosity of the laundry detergent composition. Suitable viscosity modifiers are polysaccharides, for e.g. xanthan gum, carboxymethylcellulose, organic clays (organically modified or unmodified), polycarboxylates and silicates. Some examples of additional thickeners include soluble organic or inorganic thickener material. Some examples of inorganic thickeners include clays, silicates and other well-known inorganic thickeners. Some examples of organic thickeners include thixotropic and non-thixotropic thickeners. In some preferred embodiments, the thickeners have some substantial proportion of water solubility to promote easy removability. Examples of soluble organic thickeners are, but not limited to, carboxylated vinyl polymers such as polyacrylic acids and sodium salts thereof, ethoxylated cellulose, polyacrylamide thickeners, xanthan thickeners, guar gum, sodium alginate and algin by-products, hydroxy propyl cellulose, hydroxy ethyl cellulose and other similar aqueous thickeners that have some substantial proportion of water solubility.

Fillers

The solid laundry detergent composition according to the invention may also include a minor, but effective amount of one or more of a detergent filler which does not perform as a cleaning agent per se but cooperates with the cleaning agent to enhance the overall cleaning capacity of the composition. Fillers also provide a structure to the solid laundry detergent compositions. Examples of fillers suitable for use in the present laundry detergent compositions are, but not limited to, sodium sulfate, sodium chloride, starch and sugars.

Fragrances

Suitable fragrances are those derived from natural sources or are synthetic aromatic substances. Natural aromatic substances are, for example, extracts from blossom (lilies, lavender, roses, jasmine, neroli, ylang-ylang), from stems and leaves (geranium, patchouli, petitgrain), from fruit (aniseed, coriander, carraway, juniper), from fruit peel (bergamot, lemons, oranges), from roots (mace, angelica, celery, cardamom, costus, iris, calmus), from wood (pinewood, sandalwood, guaiacum wood, cedarwood, rose-wood), from herbs and grasses (tarragon, lemon grass, sage, thyme), from needles and twigs (spruce, pine, scots pine, mountain pine), from resins and balsams (galbanum, elemi, benzoin, myrrh, olibanum, opoponax). Typical synthetic aromatic substances are, for example, products of the ester, ether, aldehyde, ketone, alcohol or hydrocarbon type. Aromatic substance compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals having from 8 to 18 hydrocarbon atoms, citral, citronellal, citronellyl oxyacetaldehyde, cyclamen aldehyde, hydroxy citronellal, lilial and bourgeonal; the ketones include, for example, the ionones, isomethylionone and methyl cedryl ketone; the alcohols include, for example, anethol, citronellol, eugenol, isoeugenol, geraniol, linalool, phenyl ethyl alcohol and terpinol; and the hydrocarbons include mainly the terpenes and balsams. Ethereal oils of relatively low volatility, which are chiefly used as aroma components, are also suitable for fragrance, e.g. sage oil, camomile oil, clove oil, melissa oil, oil of cinnamon leaves, lime blossom oil, juniper berry oil, vetiver oil, olibanum oil, galbanum oil, labolanum oil and lavandin oil.

Optical Brighteners

Optical brighteners (called “whiteners”) can be added to the laundry detergent compositions according to the invention in order to eliminate greying and yellowing of the treated textile fabrics. These substances attach to the fibres and bring about a brightening and simulated bleaching effect by converting invisible ultraviolet radiation to visible longer-wave light, with emission of the ultraviolet light absorbed from the sunlight as pale bluish fluorescence to give pure white with the yellow shade of greyed and/or yellowed laundry. Suitable optical brighteners are compounds of the substance classes of the 4,4′-diamino-2,2′-stilbenedisulfonic acids (flavonic acids), 4,4′-distyrylbiphenylene, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles.

Other Additional Ingredients

A wide variety of other ingredients, based on the state of laundry detergent composition, i.e. solid or liquid can be included, such as other active ingredients, carriers, hydrotropes, processing aids, dyes or pigments, soda ash, pearlizing polymers, biocides and other soil release polymers.

In another aspect, the presently claimed invention relates to a method for removal of particulate, greasy and bleachable stains from the fabric, said method comprising the step of contacting the fabric with a solution comprising the laundry detergent composition comprising

(a) at least one quaternized ethoxysulfated hexamethylene diamine;
(b) at least one ethoxylated polyethyleneimine; and
(c) at least one surfactant.

‘Contacting’ herein refers to contacting the fabric with the solution of the laundry detergent composition either by applying it manually, i.e. by hand on the fabric or by means of a washing machine. Contacting typically occurs by soaking, washing, rinsing or spraying the laundry detergent composition onto the fabric, but can also include contact of a substrate inter alia a material onto which the composition has been absorbed, with the fabric.

In a preferred embodiment, the presently claimed invention relates to a method for removal of particulate, greasy and bleachable stains from the fabric, said method comprising the step of contacting a fabric with a solution comprising the laundry detergent composition comprising
(a) at least one quaternized ethoxysulfated hexamethylene diamine of general formula (I);

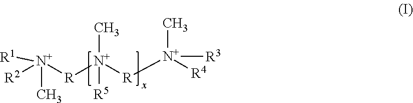

wherein
R is hexyl,
R¹, R2, R3, R4 and R5 are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4;
(b) at least one ethoxylated polyethyleneimine; and
(c) at least one surfactant.

In a preferred embodiment, the presently claimed invention relates to a method for removal of particulate, greasy and bleachable stains from a fabric, said method comprising the step of contacting the fabric with a solution comprising the laundry detergent composition comprising
(a) at least one quaternized ethoxysulfated hexamethylene diamine of general formula (I);

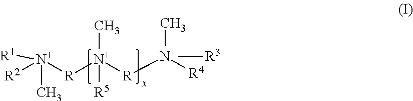

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4;
(b) at least one ethoxylated polyethyleneimine containing repeating units of the general formula (II)

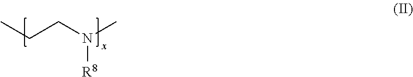

wherein
each R⁸ is independently selected from —(CH₂—CH₂—O)ₘH, or

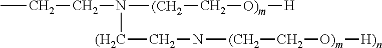

m is from 12 to 30,
n is from 1 to 20, and
x is from 10 to 30.
(c) at least one surfactant.

In another preferred embodiment, the presently claimed invention relates to a method for removal of particulate, greasy and bleachable stains from the fabric, said method comprising the step of contacting a fabric with a solution comprising the laundry detergent composition comprising
(a) at least one quaternized ethoxysulfated hexamethylene diamine of general formula (I);

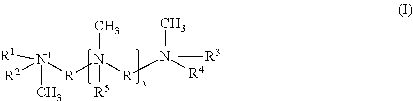

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4;
(b) at least one ethoxylated polyethyleneimine containing repeating units of the general formula (II)

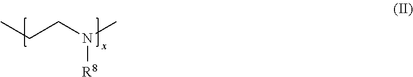

wherein
each R⁸ is independently selected from —(CH₂—CH₂—O)ₘH, or

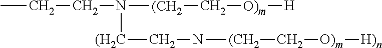

m is from 12 to 30,
n is from 1 to 20, and
x is from 10 to 30; and
(c) at least one surfactant comprising at least one anionic surfactant and at least one non-ionic surfactant.

In another preferred embodiment, the presently claimed invention relates to a method for removal of particulate, greasy and bleachable stains from a fabric, said method comprising the step of contacting the fabric with a solution comprising the laundry detergent composition comprising
(a) at least one quaternized ethoxysulfated hexamethylene diamine of general formula (I);

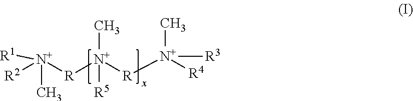

wherein
R is hexyl,
R¹, R², R³, R⁴ and R⁵ are each independently selected from (—O—CH₂—CH₂)ₙSO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4;
(b) at least one ethoxylated polyethyleneimine containing repeating units of the general formula (II)

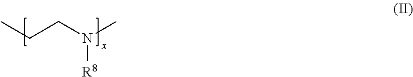

wherein
each R⁸ is independently selected from —(CH₂—CH₂—O)ₘH, or

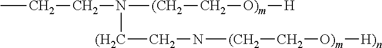

m is from 12 to 30,
n is from 1 to 20, and
x is from 10 to 30.
(c) at least one surfactant comprising at least one anionic surfactant of general formula (III)

R⁶—O—(C₂H₄O)˜—SO₃M (III)

wherein
R⁶ is selected from linear or branched, unsubstituted C₆-C₂₂ alkyl,
n is from 1 to 20, and
M is selected from alkali metal or ammonium cation;
and at least one non-ionic surfactant of general formula (IV)

R⁷—(O—CH₂—CH₂)_{q}(O—CH(CH₃)—CH₂)ᵣ—OH (IV)

wherein
R⁷ is linear or branched C₈-C₂₂-alkyl,
q is from 1 to 10, and
r is from 0 to 20.

In another preferred embodiment, the presently claimed invention relates to a method for removal of particulate, greasy and bleachable stains from a fabric, said method comprising the step of contacting the fabric with a solution comprising the laundry detergent composition comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine; and
(c) 5.0 wt. % to 50.0 wt. % of at least one surfactant.

In another preferred embodiment, the presently claimed invention relates to a method for removal of particulate, greasy and bleachable stains from a fabric, said method comprising the step of contacting the fabric with a solution comprising the liquid laundry detergent composition comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant;
(d) 10.0 wt. % to 80.0 wt. % of at least one additive; and
(e) 2.0 wt. % to 84.0 wt. % of water;
   in each case, based on the total weight of the composition.

In another preferred embodiment, the presently claimed invention relates to a method for removal of particulate, greasy and bleachable stains from a fabric, said method comprising the step of contacting the fabric with a solution comprising the solid laundry detergent composition comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant; and
(d) 10.0 wt. % to 80.0 wt. % of at least one additive;
   in each case, based on the total weight of the composition.

‘Solution’ refers to, adding the solid laundry detergent composition to water such that the solid laundry detergent composition according to the invention dissolves partly or completely in it. In case of a liquid laundry detergent composition, a solution is obtained by adding water to a liquid laundry detergent composition.

In a preferred embodiment of the present invention, the laundry detergent composition has a pH value from 7.5 to 13, more preferably from 8 to 12.5 and most preferably from 9 to 12.

In a preferred embodiment, the presently claimed invention relates to a method for removal of particulate, greasy and bleachable stains from the fabric, said method comprising the steps of
(i) diluting the laundry detergent composition described herein above, in water by a factor from 200 to 1000 to form a wash liquor; and
(ii) washing the fabrics with the wash liquor of step (i).

The steps herein described above for the removal of particulate, greasy and bleachable stains may involve additional treatment steps such as a presoak or a prewash step.

After step (ii), a rinse step for the removal of soil containing the wash liquor, several optional rinse steps to remove residual wash liquor, a softening step to soften the fabric by adding commercial softeners, and an extract step that often involves spinning the textile to remove water, may be applied.

In a preferred embodiment, the presently claimed invention relates to a method for removal of particulate, greasy and bleachable stains from a fabric, wherein the wash liquor comprises on active basis
(a) 0.5 ppm to 30.0 ppm of at least one quaternized ethoxysulfated hexamethylene diamine;
(b) 0.5 ppm to 10.0 ppm of at least one ethoxylated polyethyleneimine;
(c) 5.0 ppm to 50.0 ppm of at least one surfactant; and
(d) 3.0 ppm to 80.0 ppm of at least one additive.

In a preferred embodiment, the presently claimed invention relates to a method for removal of particulate, greasy and bleachable stains from the fabric, wherein the wash liquor comprises on active basis
(a) 2.0 ppm to 25.0 ppm of at least one quaternized ethoxysulfated hexamethylene diamine;
(b) 1.0 ppm to 9.0 ppm of at least one ethoxylated polyethyleneimine;
(c) 10.0 ppm to 48.0 ppm of at least one surfactant; and
(d) 5.0 ppm to 70.0 ppm of at least one additive.

‘Active basis’ refers to the concentration of the ingredients of the laundry detergent composition in parts per million (ppm) minus the inert ingredients such as water or salts.

In a preferred embodiment, the temperatures during laundry washing is from 20 to 70° C., preferably 20 to 60° C., more preferably 20 to 50° C.

The method for the removal of particulate, greasy and bleachable stains from the fabric may be employed with a variety of laundry washing machines, including industrial, commercial and/or consumer machines (e.g. residential and/or home laundry washing machine).

The method for the removal of particulate, greasy and bleachable stains from the fabric according to the present invention can be provided as part of an overall method for cleaning laundry according to the invention, that is, as part of a laundry cleaning operation or it can be used alone to treat the laundry.

In another aspect, the presently claimed invention relates to the use of the liquid laundry detergent composition for the removal of particulate, greasy and bleachable stains from the fabric as described herein above.

In a preferred embodiment, the laundry detergent composition of the present invention is used for the removal of particulate stains such as those due to ground-in clay. Ground-in clay stains are tough stains and are difficult to remove as these stains are not present on the surface of the fabric but instead are entrapped within the fabric.

In a preferred embodiment, the laundry detergent composition of the present invention is used for the removal of particulate stains such as those due to Georgia red clay. Stains due to Georgia red clay impart a red colour to the fabric which they stain.

In a preferred embodiment, the laundry detergent composition of the present invention is used for the removal of particulate stains such as those due to black charm soil.

In a preferred embodiment, the laundry detergent composition of the present invention is used for the removal of greasy stains such as those due to dust sebum.

In still another aspect, the presently claimed invention relates to a unit dose article comprising the laundry detergent composition as described herein above.

In a preferred embodiment, the unit dose article comprises single or multiple compartments.

In another preferred embodiment, the unit dose article is preferably a water-soluble unit dose article. The water-soluble unit dose article may be in the form of a tablet, capsule, sachet or a pouch. Preferably, the water-soluble unit dose article is a pouch.

The water-soluble unit dose article comprises at least one internal compartment surrounded by a water-soluble film. The at least one compartment comprises the laundry detergent composition. The water-soluble film is sealed such that the composition does not leak out of the compartment during storage. However, upon addition of the water-soluble unit dose article to water, the water-soluble film dissolves and releases the contents of the internal compartment into the laundry. The unit dose article is manufactured such that the water-soluble film completely surrounds the composition and in doing so defines the compartment in which the composition resides. The unit dose article may comprise two films, or even three films. A first film may be shaped to comprise an open compartment into which the composition is added. A second film may then be laid over the first film in such an orientation as to close the opening of the compartment. The first and second films may then be sealed together along a seal region.

The water-soluble unit dose article may comprise two, or even three, or even four internal compartments, preferably wherein the compartments are arranged side-by-side, in a superposed orientation or a mixture thereof. The compartments may be arranged such that two side-by-side compartments are superposed onto a third compartment wherein the third compartment is larger than the first and/or second compartments. Alternatively, the compartments may be arranged such that three side-by-side compartments are superposed onto a fourth compartment, wherein the fourth compartment is larger than the first and/or second and/or third compartments.

The unit dose article may preferably be transparent, translucent or opaque. The water-soluble film may preferably be transparent, translucent or opaque.

Preferably, the water-soluble film has a thickness of between 20 microns and 100 microns.

Preferably, the film has a water-solubility of at least 50%, preferably at least 75% or even at least 95%.

The film materials are preferably polymeric materials. Preferred polymers, copolymers or derivatives thereof suitable for use as pouch material are selected from the group of polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from the group of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin and polymethacrylates, and most preferably selected from the group of polyvinyl alcohols, polyvinyl alcohol copolymers and hydroxypropyl methyl cellulose (HPMC), and combinations thereof. Preferably, the level of polymer in the pouch material, for example a PVA polymer, is at least 60%.

The polymer can preferably have any weight average molecular weight, more preferably from about 1000 to 1,000,000, even more preferably from about 10,000 to 300,000 and still more preferably from about 20,000 to 150,000.

By incorporating a polymer made from vinyl dicarboxylic acid monomers into liquid laundry detergent composition, the composition can include at least about 30.0 wt. % water and can be packed in a water-soluble unit dose article.

The unit dose article of the present invention may be used alone in the wash operation or may be used in conjunction with other laundry additives such as fabric softeners or fragrance boosting compositions.

In another aspect, the presently claimed invention relates to a method for removal of particulate, greasy and bleachable stains from the fabric comprising the steps of diluting a water-soluble unit dose article in water by a factor of 200 to 1000 to form a wash liquor and then washing the fabrics with the said wash liquor.

### Advantages

1. A single laundry detergent composition applicable for removal of a wide variety of stains such as particulate stains due to clay or soil, greasy stains due to dust sebum and bleachable stains due to tea, coffee or fruit juices.
2. The compositions of the present invention are fabric tolerant, i.e., they will not substantially degrade the fabric on which they are applied.
3. The composition shows a better effect in terms of removal of wide variety of stains.

### Embodiments

1. A laundry detergent composition comprising
   (a) at least one quaternized ethoxysulfated hexamethylene diamine;
   (b) at least one ethoxylated polyethyleneimine; and
   (c) at least one surfactant.
2. The laundry detergent composition according to embodiment 1, wherein (a) the at least one quaternized ethoxysulfated hexamethylene diamine is a compound of general formula (I)

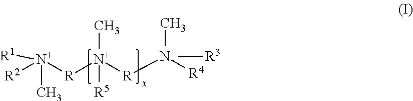

wherein
R is hexyl,
R¹, R², R³, R⁴ and R⁵ are each independently selected from (—O—CH₂—CH₂)ₙ—SO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4.
3. The laundry detergent composition according to embodiment 1, wherein (b) the at least one ethoxylated polyethyleneimine contains repeating units of the general formula (II)

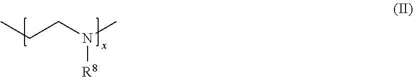

wherein
each R⁸ is independently selected from —(CH₂—CH₂—O)ₘH, or

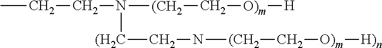

m is from 12 to 30,
n is from 1 to 20, and
x is from 10 to 30.
4. The laundry detergent composition according to embodiment 1, wherein (c) the at least one surfactant comprises at least one anionic surfactant and at least one non-ionic surfactant.
5. The laundry detergent composition according to embodiment 4, wherein the anionic surfactant is a compound of general formula (III)

R⁶—O—(C₂H₄O)ₙ—SO₃M (III)
wherein
R⁶ is linear or branched, unsubstituted C₆-C₂₂ alkyl,
n is from 1 to 20, and
M is selected from alkali metal or ammonium cation.
6. The laundry detergent composition according to embodiment 4, wherein the non-ionic surfactant is a poly(C₂-C₃)alkylene glycol mono-(C₈-C₂₂)-alkyl ether.
7. The laundry detergent composition according to embodiment 6, wherein the poly(C₂-C₃)alkylene glycol mono-(C₈-C₂₂)-alkyl ether is a compound of the general formula (IV)

R⁷—(O—CH₂—CH₂)_{q}(O—CH(CH₃)—CH₂)ᵣ—OH (IV)
wherein
R⁷ is linear or branched C₈-C₂₂-alkyl,
q is from 1 to 10, and
r is from 0 to 20.
8. The laundry detergent composition according to one or more of embodiments 1 to 7, wherein (a) is present in an amount from 0.5 wt. % to 30.0 wt. %, based on the total weight of the composition.
9. The laundry detergent composition according to one or more of embodiments 1 to 8, wherein (b) is present in an amount from 0.5 wt. % to 10.0 wt. %, based on the total weight of the composition.
10. The laundry detergent composition according to one or more of embodiments 1 to 9, wherein the weight ratio of (a) to (b) is from 0.5:1 to 2:1.
11. The laundry detergent composition according to one or more of embodiments 1 to 10, wherein (c) is present in an amount from 5 wt. % to 50 wt. %, based on the total weight of the composition.
12. The laundry detergent composition according to one or more of embodiments 1 to 11, wherein (a) has a weight average molecular weight from 2000 to 8000 g/mol.
13. The laundry detergent composition according to one or more of embodiments 1 to 12, wherein (b) has a weight average molecular weight from 400 to 15000 g/mol.
14. The laundry detergent composition according to one or more of embodiments 1 to 13 which is in liquid form.
15. The liquid laundry detergent composition according to embodiment 14 comprising
   (a) 0.5 wt. % to 30.0 wt. % of at least one quaternized ethoxysulfated hexamethylene diamine;
   (b) 0.5 wt. % to 10.0 wt. % of at least one ethoxylated polyethyleneimine;
   (c) 5.0 wt. % to 50.0 wt. % of at least one surfactant;
   (d) 10.0 wt. % to 80.0 wt. % of at least one additive; and
   (e) 2.0 wt. % to 84.0 wt. % of water;
   in each case, based on the total weight of the composition.
16. The liquid laundry detergent composition according to embodiment 15, wherein the at least one additive is selected from the group of polyacrylates, dye transfer inhibitors, solvents, enzymes, bleaching compounds, chelating agents, builders, alkali metal hydroxide, viscosity modifiers and fragrances.
17. The detergent composition according to one or more of embodiments 1 to 13 which is in solid form.
18. The solid laundry detergent composition according to embodiment 17 comprising
   (a) 0.5 wt. % to 30.0 wt. % of at least one quaternized ethoxysulfated hexamethylene diamine;
   (b) 0.5 wt. % to 10.0 wt. % of at least one ethoxylated polyethyleneimine;
   (c) 5.0 wt. % to 50.0 wt. % of at least one surfactant; and
   (d) 10.0 wt. % to 80.0 wt. % of at least one additive;
   in each case, based on the total weight of the composition.
19. The solid laundry detergent composition according to embodiment 18, wherein the at least one additive is selected from the group of polyacrylates, dye transfer inhibitors, enzymes, bleaching compounds, chelating agents, builders, alkali metal hydroxide, fillers and fragrances.
20. A method for removal of particulate, greasy and bleachable stains from the fabric, said method comprising the step of contacting the fabric with a solution comprising the detergent composition according to any one of embodiments 1 to 19.
21. The method according to embodiment 20 comprising the steps of diluting the laundry detergent composition in water by a factor of 50 to 1000 to form a wash liquor and then washing the fabric with said wash liquor.
22. The method according to embodiment 21, wherein the wash liquor comprises on active basis
   (a) 0.5 ppm to 30.0 ppm of at least one quaternized ethoxysulfated hexamethylene diamine;
   (b) 0.5 ppm to 10.0 ppm of at least one ethoxylated polyethyleneimine;
   (c) 5.0 ppm to 50.0 ppm of at least one surfactant; and
   (d) 3.0 ppm to 80.0 ppm of at least one additive.
23. Use of the laundry composition according to one or more of embodiments 1 to 19 for removal of particulate, greasy and bleachable stains from the fabric.
24. A unit dose article comprising the laundry detergent composition according to one or more of embodiments 1 to 19.
25. The unit dose article according to embodiment 24 comprising single or multiple compartments.
26. The water-soluble unit dose article according to one or more of embodiments 24 or 25.
27. A method for removal of particulate, greasy and bleachable stains from a fabric comprising the steps of diluting a water-soluble unit dose article according to any one of embodiments 23 to 26 in water by a factor of 200 to 1000 to form a wash liquor and then washing the fabric with said wash liquor.

### Experimental Section

Compounds

Component (a): Hexamethylene diamine, ethoxylated, quaternated and sulfated with a weight average molecular weight (Mw) from 2000 to 8000 g/mol
Component (b): Ethoxylated polyethyleneimine 20EO
Non-ionic surfactant 1: C₁₂-C₁₄ ethoxylated alcohol
Non-ionic surfactant 2: C₁₃ ethoxylated alcohol
Anionic surfactant: Sodium laureth sulfate, 3EO

Methods

Weight average molecular weight “Mw” is determined according to DIN 55672-1 and referred to polystyrene calibration standard.
The detergency property of the laundry detergent compositions was based on the test method ASTM D 4265-98.

Calculation of Reflectance (dE*)

dE*=The total color difference between sample (reading after wash) and stained fabric (reading before wash).
The following equation is used for calculating dE*

dE*=\sqrt{(dL*)²+(da*)²+(db*)²}

dL*=difference in lightness and darkness (+=lighter, −=darker)
da*=difference in red and green (+=redder, −=greener)
db*=difference in yellow and blue (+=yellower, −=bluer)
L*, a*, and b* are the coordinates of the CIE 1976 (L*, a*, b*) colour space, determined using a standard reflectometer.

### Examples

The laundry detergent compositions of examples 1 to 5 were prepared as per the details provided in Table-1. Each component listed in Table-1 is on the active basis.

TABLE 1
Laundry detergent compositions at the time of wash.

| | | | Non-ionic | Non-ionic | Anionic | Weight |
|---|---|---|---|---|---|---|
| | Component | Component | surfactant | surfactant | surfactant | ratio of (b) |
| Example | (a) (g) | (b) (g) | 1 (g) | 2 (g) | (g) | to (a) |
| 1 | 0.125 | 0.075 | 0.5 | 0 | 0.25 | 1.67:1 |
| 2* | 0.2 | 0 | 0.25 | 0.25 | 0.25 | |
| 3 | 0.081 | 0.12 | 0.25 | 0.25 | 0.25 | 0.675:1 |
| 4* | 0 | 0.2 | 0.25 | 0 | 0.5 | |
| 5* | 0 | 0 | 0.5 | 0 | 0.25 | |

*= not within the scope of the invention

Wash Test

Measuring detergency properties of laundry detergent composition using terg-o-tometer

Procedure:

The tested pre-soiled fabrics/swatches were 3 inches×2 inches rectangles of cotton (style #400 from Testfabrics, Inc) and polycotton (Polyester/Cotton blend of 65/35, style #7409 from Testfabrics, Inc). The tested swatches had been pre-soiled with Ground in clay, Georgia Red clay, black charm clay and dust sebum. A total of 6 swatches per soil and per fabric type and 3 un-soiled cotton swatches were used. The test was performed in a terg-o-tometer. The test fabrics were soiled with Ground in clay, Georgia Red clay, black charm clay and dust sebum. A 3 cm×2 cm white cotton fabric (style #400 from Testfabrics, Inc) on which no soil was applied was taken as control sample.

TABLE-2
Wash conditions

| Liquor Ratio (g Fabric/L water) | 18/1 | | |
|---|---|---|---|
| Water hardness | 150 ppm | | |
| pH | 11.37 | | |
| | Wash | | |
| | temperature | Wash time | Wash speed |
| | (° C.) | minutes | rpm |
| Terg-O-Tometer | 49 | 10 | 100 |
| wash conditions | | | |
| Terg-O-Tometer | 21 | 3 | 150 |
| rinse conditions | | | |

Swatches of clean, pinked pre-stained fabrics were washed, in duplicate, for 1 cycle in solutions of test laundry detergent compositions of examples 1-5. The ability of the test detergent to remove stain/soil was estimated by comparing the reflectance (dE*) of the pre-stained swatches before and after wash in the test laundry detergent composition. dE* values represent the difference between the reflectance after wash of the test detergent and the reflectance before wash. A higher value of dE* indicates better cleaning performance.

Stain Removal Efficiency

The laundry detergent compositions of examples 1 to 5 were tested for their cleaning performance on 4 soil types: Ground-in clay, Georgia red clay, black charm clay and dust sebum.

TABLE 3

| Laundry detergent | | |
|---|---|---|
| composition | dE* | Best performance observed in the removal of |
| Example 1 | 118 | Ground-in clay, Georgia red clay, black charm |
| | | clay and dust sebum |
| Example 2* | 113 | dust sebum and black charm clay |
| Example 3 | 115 | Ground-in clay, Georgia red clay, black charm |
| | | clay and dust sebum |
| Example 4* | 108 | Only dust sebum |
| Example 5* | 110 | Only dust sebum |

The composition examples 1 and 3 comprising component (a), component (b), anionic surfactant and nonionic surfactant according to the present invention, exhibited their performance in cleaning all the four soil types whereas the compositions 2, 4 and 5 which did not contain component (a) or component (b) or both, did not perform over the entire range of the soils but showed cleaning performance for only dust sebum and black charm clay.

As observed from the data of Table-3, the dE* value for swatches which were treated with laundry detergent composition of example 1 and 3 according to the invention displayed the highest dE* value, thereby indicating a high cleaning performance.

1. A laundry detergent composition comprising
(a) at least one quaternized ethoxysulfated hexamethylene diamine;
(b) at least one ethoxylated polyethyleneimine; and
(c) at least one surfactant.

2. The laundry detergent composition according to claim 1, wherein (a) the at least one quaternized ethoxysulfated hexamethylene diamine is a compound of general formula (I) 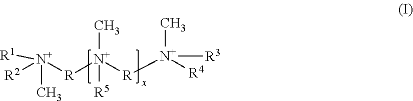
wherein
R denotes hexyl,
R¹, R², R³, R⁴ and R⁵ are each independently selected from the group consisting of (—O—CH₂—CH₂)ₙ—SO₃M and (—O—CH₂—CH₂)ₙ—H; wherein at least one of R¹, R², R³, R⁴ and R⁵ is (—O—CH₂—CH₂)ₙ—SO₃M,
M is H or alkali metal cation,
n is from 15 to 30, and
x is from 0 to 4.

3. The laundry detergent composition according to claim 1, wherein (b) the at least one ethoxylated polyethyleneimine contains repeating units of a general formula (II) 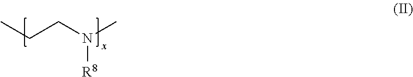
wherein
each R⁸ is independently selected from the group consisting of —(CH₂—CH₂—O)ₘH and 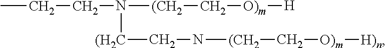
m is from 12 to 30,
n is from 1 to 20, and
x is from 10 to 30.

4. The laundry detergent composition according to claim 1, wherein (c) the at least one surfactant comprises at least one anionic surfactant and at least one non-ionic surfactant.

5. The laundry detergent composition according to claim 4, wherein the anionic surfactant is a compound of general formula (III)
R⁶—O—(C₂H₄O)ₙ—SO₃M (III)
wherein
R⁶ is linear or branched, unsubstituted C₆-C₂₂ alkyl,
n is from 1 to 20, and
M is selected from the group consisting of alkali metal and ammonium cation.

6. The laundry detergent composition according to claim 4, wherein the non-ionic surfactant is a poly(C₂-C₃)alkylene glycol mono-(C₈-C₂₂)-alkyl ether.

7. The laundry detergent composition according to claim 6, wherein the poly(C₂-C₃)alkylene glycol mono-(C₈-C₂₂)-alkyl ether is a compound of a general formula (IV)
R⁷—(O—CH₂—CH₂)_{q}(O—CH(CH₃)—CH₂)ᵣ—OH (IV)
wherein
R⁷ is linear or branched C₈-C₂₂-alkyl,
q is from 1 to 10, and
r is from 0 to 20.

8. The laundry detergent composition according to claim 1, wherein (a) is present in an amount from 0.5 wt. % to 30 wt. %, based on a total weight of the composition.

9. The laundry detergent composition according to claim 1, wherein (b) is present in an amount from 0.5 wt. % to 10 wt. %, based on a total weight of the composition.

10. The laundry detergent composition according to claim 1, wherein a weight ratio of (a) to (b) is from 0.5:1 to 2:1.

11. The laundry detergent composition according to claim 1, wherein (c) is present in an amount from 5 wt. % to 50 wt. %, based on a total weight of the composition.

12. The laundry detergent composition according to claim 1, wherein (a) has a weight average molecular weight from 2000 to 8000 g/mol.

13. The laundry detergent composition according to claim 1, wherein (b) has a weight average molecular weight from 400 to 15000 g/mol.

14. The laundry detergent composition according to claim 1, wherein the laundry detergent composition is in liquid form.

15. The liquid laundry detergent composition according to claim 14, comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant;
(d) 10.0 wt. % to 80.0 wt. % of at least one additive; and
(e) 2.0 wt. % to 84.0 wt. % of water;
in each case, based on a total weight of the composition.

16. The liquid laundry detergent composition as claimed in claim 15, wherein the at least one additive is selected from the group consisting of polyacrylates, dye transfer inhibitors, solvents, enzymes, bleaching compounds, chelating agents, builders, alkali metal hydroxide, viscosity modifiers, and fragrances.

17. The laundry detergent composition according to claim 1, wherein the laundry detergent composition is in solid form.

18. The solid laundry detergent composition according to claim 17, comprising
(a) 0.5 wt. % to 30.0 wt. % of at least one quaternized ethoxysulfated hexamethylene diamine;
(b) 0.5 wt. % to 10.0 wt. % of at least one ethoxylated polyethyleneimine;
(c) 5.0 wt. % to 50.0 wt. % of at least one surfactant; and
(d) 10.0 wt. % to 80.0 wt. % of at least one additive;
in each case, based on a total weight of the composition.

19. The solid laundry detergent composition as claimed in claim 18, wherein the at least one additive is selected from the group consisting of polyacrylates, dye transfer inhibitors, enzymes, bleaching compounds, chelating agents, builders, alkali metal hydroxide, fillers, and fragrances.

20. A method for removal of particulate, greasy, or bleachable stains from a fabric, said method comprising the step of contacting the fabric with a solution comprising the laundry detergent composition according to claim 1.

21. The method according to claim 20 comprising the steps of diluting the laundry detergent composition in water by a factor of 50 to 1000 to form a wash liquor and then washing the fabric with said wash liquor.

22. The method according to claim 21, wherein the wash liquor comprises on an active basis
(a) 0.5 ppm to 30.0 ppm of at least one quaternized ethoxysulfated hexamethylene diamine;
(b) 0.5 ppm to 10.0 ppm of at least one ethoxylated polyethyleneimine;
(c) 5.0 ppm to 50.0 ppm of at least one surfactant; and
(d) 3.0 ppm to 80.0 ppm of at least one additive.

23. A method of using the laundry composition according to claim 1, the method comprising using the laundry composition for removal of particulate, greasy, or bleachable stains from a fabric.

24. A unit dose article comprising the laundry detergent composition according to claim 1.

25. The unit dose article according to claim 24 comprising single or multiple compartments.

26. The unit dose article according to claim 24, wherein the unit dose article is water-soluble.

27. A method for removal of particulate, greasy, or bleachable stains from a fabric comprising the steps of diluting the water-soluble unit dose article according to claim 26 in water by a factor of 200 to 1000 to form a wash liquor and then washing the fabric with said wash liquor.
